(19) United States
(12) Patent Application Publication
(10) Pub. No.: US 2016/0248235 A1
(43) Pub. Date: Aug. 25, 2016

(54) PROTECTOR FOR WIRE HARNESS

(71) Applicant: SUMITOMO WIRING SYSTEMS, LTD., Mie (JP)

(72) Inventor: Hitoshi ITOU, Mie (JP)

(73) Assignee: SUMITOMO WIRING SYSTEMS, LTD., Mie (JP)

(21) Appl. No.: 15/027,865

(22) PCT Filed: Sep. 29, 2014
(86) PCT No.: PCT/JP2014/075783

§ 371 Date: Apr. 7, 2016

(30) Foreign Application Priority Data
Oct. 15, 2013 (JP) 2013-214801

(51) Int. Cl. H02G 3/04; H01B 7/00

(52) U.S. Cl. CPC H02G 3/0468; H01B 7/0045

(57) ABSTRACT

A protector for a wire harness can shorten a length of a protector main body in an axis direction and securely lock the protector main body with a lid. A protector for a wire harness into which wire harness wires are inserted is provided with a protector main body housing the wires and a lid mounted on the protector main body to be capable of opening and closing. The protector is also provided with a first lock portion that locks the protector main body and the lid in a certain length area; and a second lock portion that locks the protector main body and the lid in a certain width area. Further, a branching exit is provided to the protector in order to draw out a branched portion branching off the wires between the first lock portion and the second lock portion when the lid is in a closed state.

### FIELD OF THE INVENTION

The present invention relates to a protector for a wire harness to be mounted in order to protect wires in the wire harness, when routing the wire harness in a panel of a vehicle, for example.

### BACKGROUND OF THE INVENTION

Conventionally, when a wire harness is routed in a vehicle panel, the wire harness is sheathed with a molded protector, which is a plastic sheathing component, for electric wire protection and path regulation. Normally, the molded protector includes a protector main body housing the wire harness and a lid to be locked with the protector main body.

As shown in FIG. 7, as an example of such a molded protector, a protector 10 has already been proposed which facilitates locking connection of locking portions 26 on a protector main body 11 and a lid 12 when the locking portions 26 cannot be formed at opposing locations on both sides of the protector 10 (see Patent Document 1, for example).

### SUMMARY OF THE INVENTION

### Problems to Be Solved by the Invention

However, while the conventional protector 10 can facilitate locking connection of the protector main body 11 with the lid 12, even when a locking portion 26 cannot be formed on a first end side of a vehicle fixating portion 2 due to the shortened distance from an end 17a to the first side, it has been difficult to securely lock the lid 12 on the first end side.

In other words, the conventional protector 10 described above has a structure that includes, on the first end side, a protruding piece 28 (instead of a locking portion 26) and a narrow width L-shaped stopper 29 that contacts a bottom end of the protruding piece 28. Therefore, the protector main body 11 and the lid 12 cannot be securely locked.

In a protector such as the protector 10, the protector main body 11 and the lid 12 are preferably capable of securely locking in order to protect the wires. In order to provide secure locking, however, the locking portions 26 must be provided on the opposing sides of the protector 10.

The lock portions 26 require some flexibility that allows a lock claw 26a to be pushed into a lock claw engagement frame 26b. Therefore, the lock portions 26 must be formed with a predetermined width. Therefore, in order to provide the lock portions 26, the protector main body 11 needs to be made longer than an axial direction length of the wires to be protected.

However, the conventional protector 10 cannot have the protector main body 11 formed in an unnecessarily long length in a case where the vehicle fixating portion 27 is formed near the end 17a or where the length between the end 17a and the vehicle fixating portion 27 must be short. Accordingly, there is a problem in the conventional technology which made it difficult to securely lock the protector main body 11 with the lid 12.

In view of the circumstances above, the present invention provides a protector for a wire harness which shortens an axial direction length of a protector main body, while securely locking the protector main body with a lid.

### Means for Solving the Problems

A protector for a wire harness according to the present invention protects wire harness wires inserted through the protector, and the protector includes a protector main body that has a trough-shaped recess housing the wires; and a lid member mounted to be capable of opening and closing on an opening side of the protector main body. The protector main body and the lid member have a plurality of lock portions that mutually engage when the lid member is closed and retain a closed state of the lid member. The plurality of lock portions are configured with a first lock portion and a second lock portion, the first lock portion locking the protector main body and the lid member in a certain length area in an axis direction of the trough-shaped recess, the second lock portion locking the protector main body and the lid member in a certain width area of the trough-shaped recess. When the lid member is in the closed state, an additional function shaped portion is provided between the first lock portion and the second lock portion, the additional function shaped portion branching and supporting the wires.

With the configuration described above, according to the wire harness protector of the present invention, the second lock portion can lock the protector main body and the lid member in a certain width area of the trough-shaped recess housing the wires. Therefore, even when the additional function shaped portion is provided, the length of the protector main body in the axis direction can be sufficiently shortened while securely maintaining the closed state of the protector main body with the lid member.

The additional function shaped portion described above may include a branched exit that branches off a portion of the wires, or a vehicle fixating portion for supporting the wires on the vehicle body.

In the protector for a wire harness according to the present invention, the first lock portion may be configured with a first engagement projection and a first engagement recess, the first engagement projection having a hook-shaped engagement claw on a forefront end, the first engagement recess being engaged with the engagement claw of the first engagement projection. Further, the second lock portion may be configured with a second engagement projection and a second engagement recess, the second engagement projection having a hook-shaped engagement claw on a forefront end, the second engagement recess being engaged with the engagement claw of the second engagement projection. In addition, the engagement claw of the first engagement projection which is provided with the first engagement recess and the engagement claw of the second engagement projection engaged with the second engagement recess may be substantially orthogonal to each other.

With the configuration described above, according to the wire harness protector of the present invention, the second lock portion locking the protector main body and the lid member has a shortened length in the axis direction of the trough-shaped recess portion housing the wires, the length being substantially the same as a combined thickness of the second engagement projection and the second engagement recess. Accordingly, the protector main body and the lid member are securely locked, and the additional function shaped portion may be positioned near the end portion of the protector main body.

In the protector for a wire harness according to the present invention, the second engagement recess may be provided with a reinforcement member that ensures a degree of strength of the second lock portion.

With the configuration described above, according to the wire harness protector of the present invention, the strength of the second lock portion may be increased against a load applied when the lid member is closed.

In the protector for a wire harness according to the present invention, the second engagement recess may be provided with an opening below the second engagement recess.

With the configuration described above, according to the wire harness protector of the present invention, the opening enlarges an open area of the first end portion of the protector main body, thereby easily accommodating an increased amount of wire harness wires to be inserted through the protector main body.

### Effect of the Invention

The present invention provides a protector for a wire harness which shortens an axial direction length of a protector main body, while securely locking the protector main body with a lid.

### BRIEF DESCRIPTION OF THE DRAWINGS

FIG. 1 is an external perspective view of a protector according to a first embodiment of the present invention;

FIG. 2 is an expanded view of a main portion illustrating a portion of the protector shown in FIG. 1;

FIG. 3 is a perspective view of a main portion of a protector according to a second embodiment of the present invention;

FIG. 4 is an expanded view of the main portion illustrating a portion of the protector shown in FIG. 3;

FIG. 5 is a perspective view of a main portion of a protector according to a third embodiment of the present invention;

FIG. 6 is an expanded view of the main portion illustrating a portion of the protector shown in FIG. 5; and

FIG. 7 is an exploded perspective view of a conventional protector.

### MODE FOR CARRYING OUT THE INVENTION

Hereafter, embodiments of the present invention are described with reference to the drawings. In each of the embodiments, descriptions are given of cases where the invention is applied to a protector for a wire harness to be routed in a panel of a vehicle, such as an automobile.

### First Embodiment

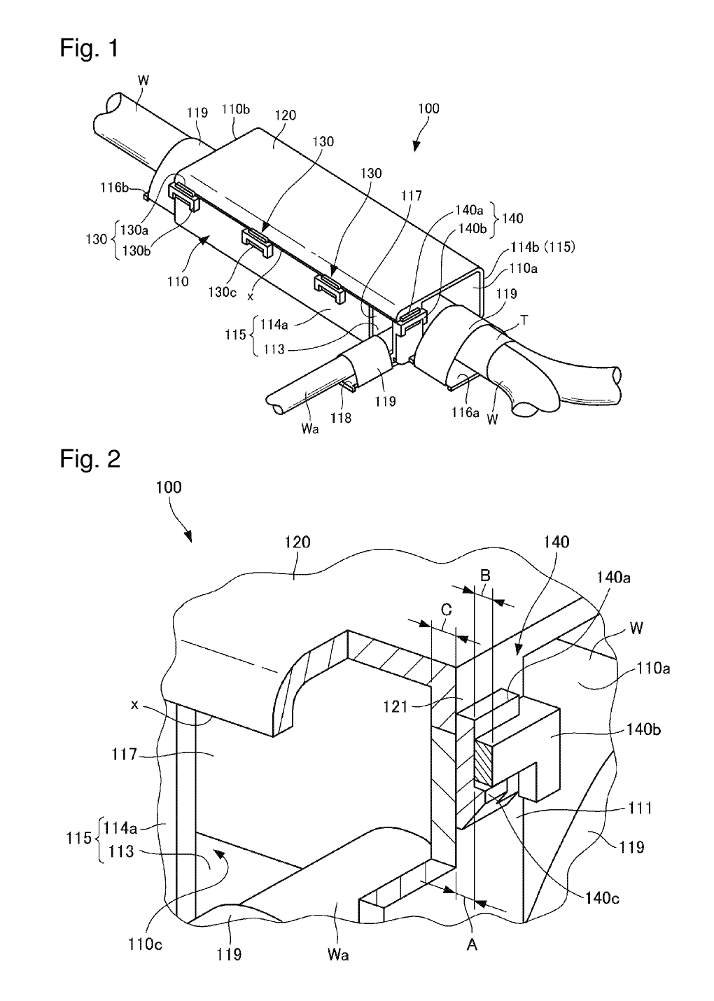

FIG. 1 illustrates a protector 100 according to a first embodiment of the present invention.

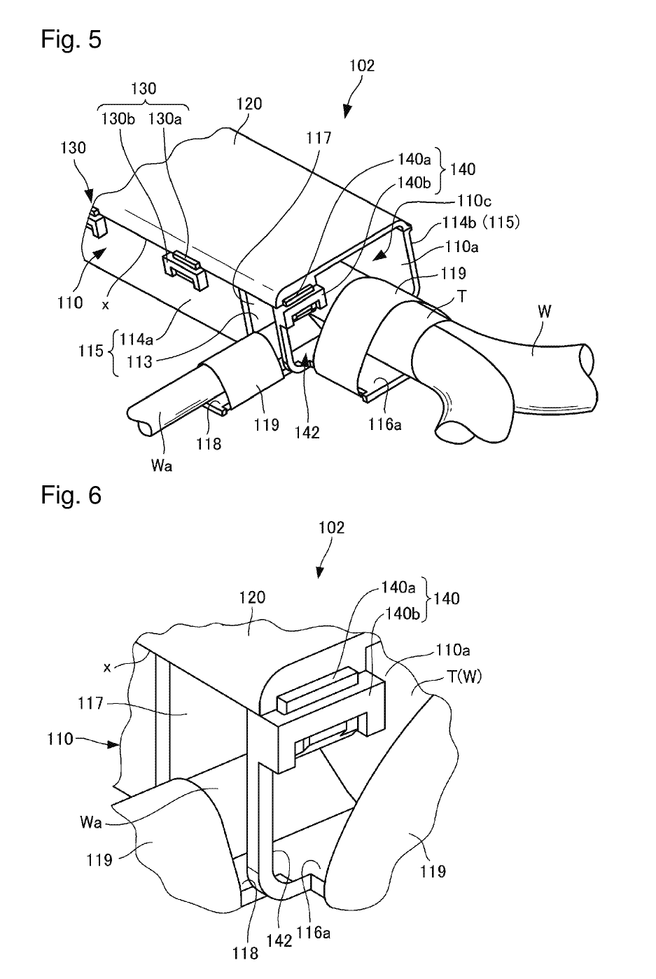

The protector 100 includes a protector main body 110 that opens on a top surface and into which wire harness wires W are inserted; and a lid 120 that covers the open top surface of the protector main body 110 by forming a locking connection. The protector main body 110 has a trough-shaped depression 110c that houses the wire harness wires W along a length direction of the protector main body 110 (see FIG. 5). The lid 120 is mounted to the protector main body 110 to be capable of opening and closing on an opening side X of the protector main body 110.

In the present embodiment, the lid 120 is a lid member according to the present invention. Further, the length direction is an axis direction of the trough-shaped depression of the protector main body 110.

The protector 100 is a molded protector such as a plastic sheathing member (e.g., resin molded product) and is mounted in order to protect and regulate paths of the wire harness wires W, when routing the wire harness wires W in a panel of a vehicle, for example.

As to the wire harness wires W, a corrugated tube T is externally provided on front and back areas of a wire insertion portion 115 (described later) of the protector 100, and only the wires W are inserted through the wire insertion portion 115 of the protector 100, without the corrugated tube T sheathing the wires.

Further, the corrugated tube T may continue to sheathe the wire harness wires W even into the area inserted into the protector 100, or the corrugated tube T sheathing may be omitted.

The corrugated tube T is provided with alternating annular recesses and projections (not shown in the drawings) with respect to the axis direction so as to be flexible.

In the present embodiment, the wire harness wires W have a branched portion Wa as branch wires. The branched portion Wa is provided to branch off a portion of the wire harness wires W and direct the branched wires to a different direction from the axis direction, for example, an orthogonal direction.

The protector main body 110 includes a trough-shaped wire insertion portion 115 and flat plate-shaped tube fixing portions 116a and 116b. The wire insertion portion 115 has a bottom wall 113 and two side walls 114a and 114b. The tube fixing portions 116a and 116b are continuously formed on a first end portion 110a and a second end portion 110b, respectively, of the axis direction of the wire insertion portion 115. Inner circumferential surfaces of the tube fixing portions 116a and 116b may be provided with a plurality of ribs to fit with the recesses of the corrugated tube T.

In order to draw out the branched portion Wa in a direction orthogonal to the axis direction, the protector main body 110 has a branched exit 117 and a flat plate-shaped branch fixing portion 118. The branched exit 117 is an opening provided to a first side wall 114a proximate to the first end portion 110a, and the branch fixing portion 118 is continuously formed on the wire insertion portion 115 in a portion corresponding to the branched exit 117. The branched exit 117 is an additional function shaped portion that branches off the wires according to the present invention.

In the branched portion Wa, when the corrugated tube T is sheathing the area coming out of the protector 100, an inner circumferential surface of the branch fixing portion 118 may be provided with a plurality of ribs to fit with the recesses of the corrugated tube T.

The wire harness wires W are fixated on the tube fixing portions 116a and 116b with a tape 119, and the branched portion Wa is also fixated on the branch fixing portion 118 with the tape 119.

The lid 120 is formed to have a substantially flat plate shape to correspond to the shape of the wire insertion portion 115 of the protector main body 110.

The lid 120 and the protector main body 110 are provided with a first lock portion 130 and a second lock portion 140 on the opening side X, the first and second lock portions mutually engaging when the lid 120 is closed and the closed state of the lid 120 is retained.

When the lid 120 is in the closed state, the branched exit 117 is positioned between the first lock portion 130 and the second lock portion 140.

In this example, there are a plurality of first lock portions 130 (three, for example) spaced at predetermined interval apart in the axis direction of the protector main body 110, which lock together the protector main body 110 and the lid 120 in a certain length area in the axis direction. The certain length area described above refers to a predetermined width of the first lock portion 130 with respect to the axis direction.

The first lock portion 130 includes a lock claw 130a and a lock claw engagement frame 130b. The lock claw 130a projects from a forefront end outer surface of the lid 120 on the opening side X and has a hook-shaped engagement claw 130c on the forefront end. The lock claw engagement frame 130b projects from a top end outer surface of the side wall 114a of the protector main body 110 on the opening side X, and engages with the forefront end of the lock claw 130a. The lock claw 130a is a first engagement projection according to the present invention, and the lock claw engagement frame 130b is a first engagement recess according to the present invention.

Meanwhile, there is at least one second lock portion 140 provided on the first end portion 110a of the axis direction of the protector main body 110, provided in the width direction of the protector main body 110, so as to lock together the protector main body 110 and the lid 120 in a certain width area with respect to the axis direction. The certain width area described above refers to a predetermined width of the second lock portion 140 with respect to the direction orthogonal to the axis direction.

The second lock portion 140 includes a lock claw 140a and a lock claw engagement frame 140b. The lock claw 140a projects from an end portion outer surface of the lid 120 on the opening side X and has a hook-shaped engagement claw 140c on a forefront end (see FIG. 2). The lock claw engagement frame 140b projects from an end portion outer surface of the protector main body 110 on the opening side X, and engages with the forefront end of the lock claw 140a. The lock claw 140a is a second engagement projection according to the present invention, and the lock claw engagement frame 140b is a second engagement recess according to the present invention.

In the present embodiment, the second lock portion 140 is arranged in a direction rotated approximately 90° with respect to the first lock portion 130. Specifically, the engagement claw 130c (of the lock claw 130a engaged with the lock claw engagement frame 130b) and the engagement claw 140c (at the forefront end of the lock claw 140a engaged with the lock claw engagement frame 140b) are substantially orthogonal to each other.

In other words, the second lock portion 140 is provided in the width direction of the protector main body 110 at the first end portion 110a. Accordingly, it is possible to reduce the length in the axis direction required to provide the second lock portion 140. Therefore, even when the branched portion Wa and the branched exit 117 are provided near the first end portion 110a of the axis direction of the protector main body 110, it becomes possible to shorten the distance between the first end portion 110a and the branched exit 117 of the protector main body 110, while securely locking the protector main body 110 with the lid 120.

FIG. 2 is an expanded view of a main portion illustrating a portion of the protector 100 shown in FIG. 1.

As shown in FIG. 2, the first end portion 110a of the axis direction of the protector main body 110 is provided with the lock claw 140a having the hook-shaped engagement claw 140c on the forefront end, the lock claw 140a projecting downward from an end portion outer surface 121 of the lid 120 on the opening side X.

Further, an end portion outer surface 111 of the protector main body 110 on the opening side X is provided with the lock claw engagement frame 140b projecting in the axis direction.

In other words, in the second lock portion 140, when the lid 120 is closed, the engagement claw portion 140c of the lock claw 140a is engaged with the lock claw engagement frame 140b.

With the configuration described above, the second lock portion 140 has a length in the axis direction which is substantially the same as a sum combining thickness A (of the lock claw 140a member) and thickness B (of the lock claw engagement frame 140b member). Accordingly, compared to the conventional protector, the protector 100 allows the second lock portion 140 of the protector 100 to have a shortened length with respect to the axis direction of the protector main body 110.

As described above, the protector 100 according to the present embodiment can securely lock the protector main body 110 with the lid 120 at the end portion 110a and has shortened length in the axis direction, even when the branched exit 117 is positioned near the end portion 110a.

In other words, since the protector 100 is provided with the second lock portion 140 along the width direction of the protector main body 110, the distance between the first end portion 110a and the branched exit 117 of the protector main body 110 in the axis direction can be shortened to thickness C (of the end portion outer surface 121 member of the lid 120). Further, even with the shortened distance as described above, the protector 100 can securely maintain the closed state of the lid 120.

Therefore, with the protector 100, it is possible to resolve the problem of the lid 120 lifting up during the closed state, even when the length of the protector 100 is shortened or the branched exit 117 is positioned near the first end portion 110a due to a layout requirement of a battery in a vehicle or the like.

### Second Embodiment

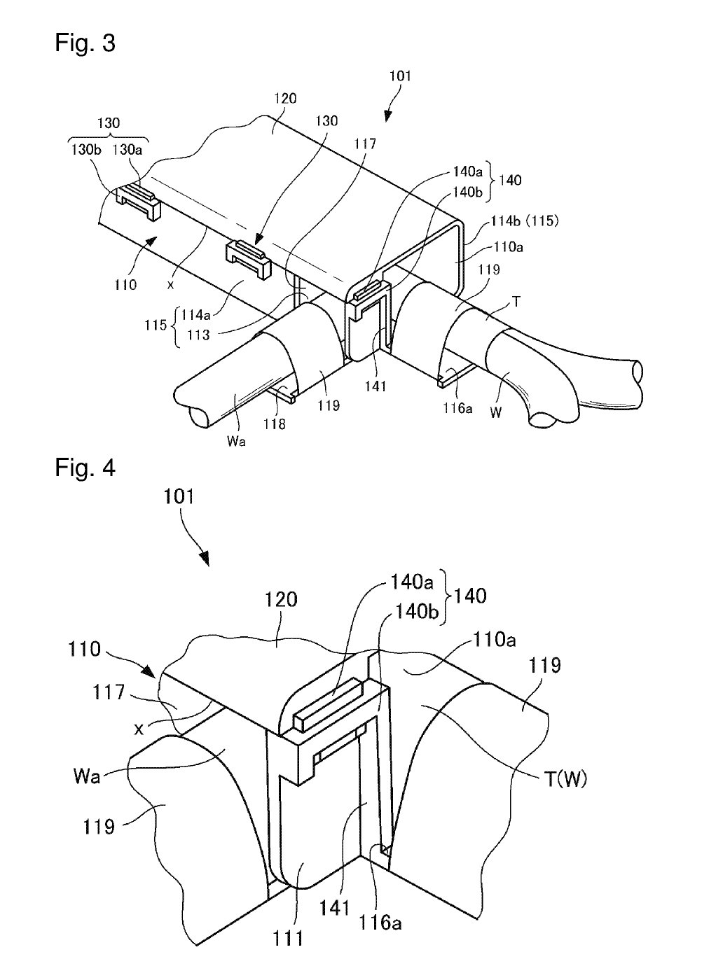

FIGS. 3 and 4 illustrate a protector 101 according to a second embodiment of the present invention. A configuration that is the same as in the protector 100 of the first embodiment is indicated using the same reference numeral as in the first embodiment and detailed description is omitted.

As shown in FIG. 3, the protector 101 according to the present embodiment has a rib 141 formed on the lock claw engagement frame 140b that configures the second lock portion 140, thereby improving strength of the second lock portion 140.

In other words, the lock claw engagement frame 140b is provided with the rib 141 as a reinforcement member, in order to secure the strength of the second lock portion 140.

As shown in FIG. 4, the rib 141 extends downward from an end of the lock claw engagement frame 140b, and is formed to have a length that reaches the tube member 116a. Accordingly, the protector 101 can securely maintain the closed state of the lid 120, while improving the strength of the second lock portion 140 against a load applied when the lid is closed, even when the distance between the first end portion 110a and the branched exit 117 of the protector main body 110 in the axis direction is shortened.

However, in the case of the protector 101 according to the present embodiment, when the wire harness wires W are fixated to the tube fixing portion 116a, the tape 119 needs to be wound while leaving a portion of the wires not wrapped for the length of the rib 141 in the axis direction. Therefore, compared to the protector 100 according to the first embodiment, the shortening effect is smaller although the difference is very small.

### Third Embodiment

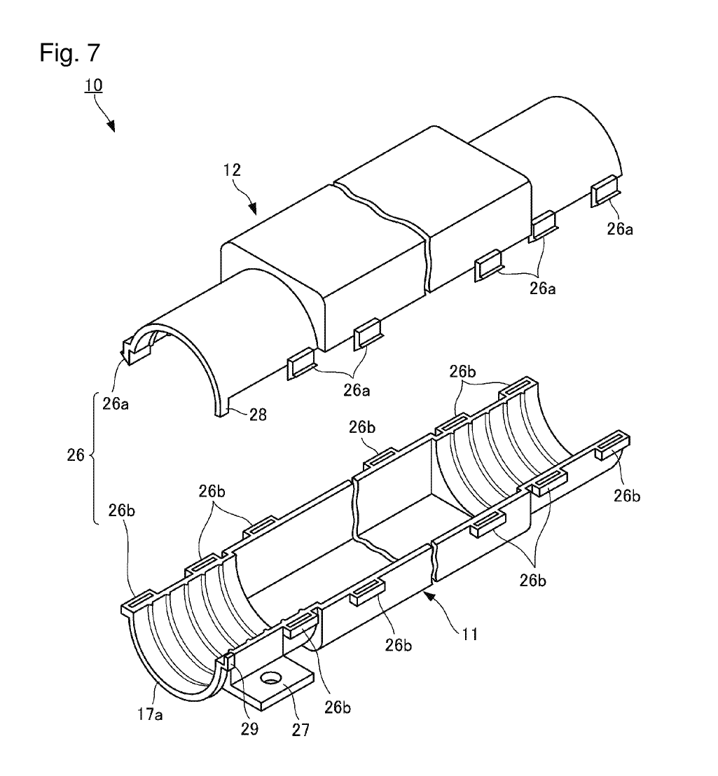

FIGS. 5 and 6 illustrate a protector 102 according to a third embodiment of the present invention. A configuration that is the same as in the protector 100 of the first embodiment is indicated using the same reference numeral as in the first embodiment and detailed description is omitted.

As shown in FIG. 5, the protector 102 according to the present embodiment has an opening 142 formed below the lock claw engagement frame 140b that configures the second lock portion 140, thereby enlarging the open area of the first end portion 110a of the protector main body 110.

As shown in FIG. 6, the opening 142 is formed below the lock claw engagement frame 140b and is connected to the opening of the first end portion 110a of the protector main body 110. Accordingly, the protector 102 can securely maintain the closed state of the lid 120, even when the distance between the first end portion 110a and the branched exit 117 of the protector main body 110 in the axis direction is shortened. Further, the protector 102 easily accommodates an increased amount of wire harness wires W to be inserted through the protector 102.

As described above, with any of the protectors 100, 101, and 102 according to the first through the third embodiments, using the second lock portion 140 makes it possible to lock the protector main body 110 with the lid 120, in a certain width area of the protector main body 110 housing the wire harness wires W.

In other words, in each of the embodiments described above, the second lock portion 140 is provided along the width direction of the protector main body 110 at the first end portion 110a of the axis direction of the protector main body 110, so that the angle of the second lock portion 140 relative to the first lock portion 130 is substantially 90°. Accordingly, it becomes possible to securely lock the protector main body 110 with the lid 120 at the end portion 110a. Therefore, even when the branched portion Wa and the branched exit 117 are provided near the end portion 110a, the length of the protector 100 in the axis direction can be sufficiently shortened while maintaining the closed state of the protector main body 110 with the lid 120.

Further, in addition to a case where the branched portion Wa and the branched exit 117 are provided near the end portion 110a, even when there is a need to retreat the position of the wire harness wires W on a component side (e.g., vehicle battery side), the length of the protector 100 in the axis direction can be sufficiently shortened while maintaining the closed state of the protector main body 110 with the lid 120.

In each of the embodiments described above, the description were given using a case where the branched portion Wa and the branched exit 117 are provided near the end portion 110a. However, the present invention is not limited to this, and a similar effect can be achieved when a vehicle fixating portion and the like are provided near the end portion 110a in order to fixate the protector 100, 101, or 102.

In this case, the vehicle fixating portion has a hole into which a bolt is inserted, and acts as an additional function shaped portion that supports wire harness wires to be routed in the vehicle panel.

Without being limited to each of the embodiments described above, a protector may also be provided with the protector main body 110 and the lid 120 as separate components.

Further, while descriptions are given for a protector for a wire harness to be routed in a panel of a vehicle in each of the embodiments, the invention is not limited to this.

As described above, the protector for a wire harness according to the present invention can shorten the length in the axis direction while securely locking the protector main body with the lid even with the shortened length, and can be used in all wire harness protectors for wire protection and path regulation.

### DESCRIPTION OF REFERENCE NUMERALS

100, 101, 102 protector
110 protector main body
110a end portion
117 branched exit
120 lid
130 first lock portion
130a lock claw
130b lock claw engagement frame
130c engagement claw
140 second lock portion
140a lock claw
140b lock claw engagement frame
140c engagement claw
141 rib (reinforcement member)
142 opening
W wire harness wires
Wa branched portion

### RELATED ART

### Patent Literature

Patent Literature 1: Japanese Patent Laid-open Publication No. 2008-86171

1. A protector for a wire harness that protects wire harness wires inserted through the protector, comprising:
a protector main body that has a trough-shaped recess housing the wires; and
a lid member configured to be mounted on the protector main body for closing an opening side of the protector main body,
wherein the protector main body and the lid member have a plurality of lock portions that mutually engage when the lid member is closed and retain a closed state of the lid member,
wherein the plurality of lock portions are configured with a first lock portion and a second lock portion, the first lock portion locking the protector main body and the lid member in a length area in an axis direction of the trough-shaped recess, the second lock portion locking the protector main body and the lid member in a width area of the trough-shaped recess, and
wherein when the lid member is in the closed condition, an additional function shaped portion is provided between the first lock portion and the second lock portion, the additional function shaped portion branching and supporting the wires.

2. The protector for a wire harness according to claim 1,
wherein the first lock portion is configured with a first engagement projection and a first engagement recess, the first engagement projection having a hook-shaped engagement claw on a forefront end, the first engagement recess being engaged with the engagement claw of the first engagement projection,
wherein the second lock portion is configured with a second engagement projection and a second engagement recess, the second engagement projection having a hook-shaped engagement claw on a forefront end, the second engagement recess being engaged with the engagement claw of the second engagement projection, and
wherein the engagement claw of the first engagement projection which is engaged with the first engagement recess and the engagement claw of the second engagement projection which is engaged with the second engagement recess are substantially orthogonal to each other.

3. The protector for a wire harness according to claim 2, wherein the second engagement recess is provided with a reinforcement member that ensures a degree of strength of the second lock portion.

4. The protector for a wire harness according to claim 2, wherein the second engagement recess is provided with an opening below the second engagement recess.
